(19) United States
(12) Patent Application Publication
(10) Pub. No.: US 2008/0257180 A1
(43) Pub. Date: Oct. 23, 2008

(54) Dampening Control for a Printing Press

(75) Inventors: Ian Michael Buckley, Lancashire (GB); Myles Robert Taylor, Northampton (GB)

Correspondence Address: CHADBOURNE & PARKE LLP, 30 ROCKEFELLER PLAZA, NEW YORK, NY, 10112, US

(73) Assignee: Goss Graphic Systems Limited, Lancashire (GB)

(21) Appl. No.: 11/573,304

(22) PCT Filed: Jul. 26, 2005
(86) PCT No.: PCT/EP2005/053647

§ 371 Date: Nov. 26, 2007

(30) Foreign Application Priority Data
Aug. 6, 2004 (GB) 0417586.5

(51) Int. Cl. B41L 25/06; B41F 33/00

(52) U.S. Cl. 101/147; 340/540

(57) ABSTRACT

Apparatus for dampening a printing press comprises a spray bar (26) with solenoid operated nozzles (29) for dispensing a dampening fluid to the press, a controller (30) that sets the flow rate of the dampening fluid to the press through the nozzles, and workstation (31) operable to drive the controller (30). The nozzles (29) are to set an initial flow rate for the commencement of a print run, corresponding to an initial setting value (IS) dependent on a default value (D) and a stored value (AVOFS) derived during at least one preceding print run, and then the setting is updated during the print run by updated data (AS) corresponding to an updated flow rate for the commenced print run. An offset value (OFS) is then calculated based on the difference between (IS) and (AS). The stored value (AVOFS) is then calculated based on a running average of (OFS) for successive print runs.

### FIELD OF THE INVENTION

This invention relates to an improved apparatus and method for dampening a printing press, and has particular but not exclusive application to a rotary offset printing press.

### BACKGROUND

A web-offset rotary printing press comprises a number of printing units designed to print matter onto a continuous web of print medium, such as paper, travelling through each print unit. Each unit contains a cylinder group or print couple pair that comprises a rotatably mounted plate cylinder, to which one or more printing plates are attached, and a rotatably mounted blanket cylinder. Many presses of this type incorporate a shaftless drive system in which each cylinder group is driven by its own drive motor which directly drives one of the cylinders of the group via a belt or gear drive. The cylinders within each cylinder group are typically coupled mechanically so that drive is transferred from the directly driven cylinder to the other cylinders of that group.

An inking system is associated with each print couple, comprising a train of ink rollers operable to feed ink onto the printing plates as the plate cylinder rotates. The web of print medium passes between the blanket cylinder and an impression cylinder. The cylindrical surfaces of the plate and blanket cylinder are in rolling contact, so that an inked image is transferred onto the blanket cylinder from the plate cylinder and, from the blanket cylinder, to the print medium. To enable the paper web to be printed on both sides, the impression cylinder is actually the blanket cylinder of another print couple including a plate cylinder having printing plates to which ink is transferred from another inking system roller train. Thus, a pair of print couples is provided, with each couple on an opposite side of the paper web, which runs between them.

Each printing unit has a frame to which each print couple and its respective inking system are mounted. The printing unit also has a dampening system associated with each inking unit also mounted to the frame.

The printing units are spaced from each other and aligned with a folder unit so that the paper web is fed through each print unit from a separate reelstand mounted below or to one side of each printing unit at floor level and then travels in a lateral direction away from the unit and into the folder. A slitting mechanism is located between the print unit and the folder, for cutting the web into separate ribbons. Turner bars are provided for turning one or more of the ribbons to orientate them before they enter the folder.

In large scale high volume presses used for example in the printing of newspapers, multi-colour printing is achieved by providing each printing unit with a number of printing couple pairs mounted vertically one above the other in a stack so that the paper web travels in a vertically upward direction between each pair of print couples from the reelstand. A unit having four printing couple pairs, i.e. eight print couples, is able to print up to four colours on each side of the paper web and is often known as a “four-high” unit. A unit having a different number of print couple pairs is also possible depending on the application to which the press is to be put and the quality and number of colours to be printed. For example, a “five-high” unit having five print couple pairs is also known. When a printed web emerges from the upper end of each print unit it is passed over a roller having an axis of rotation at right angles to the direction of travel of the web. As the web passes over the roller its upward direction of travel is changed so that it now travels in a lateral direction along the press and towards the folder.

Considering the inking system in more detail, it includes a metering element to meter the ink film supplied through the ink roller train to the print cylinder. The inking system may comprise a fountain inker in which a fountain of ink washes over an inking roller and is then transferred through the inking system roller train to the plates on the plate cylinder. An alternative inking approach is used in the Goss Colorflow™ system in which helical brushes transfer ink from an ink source onto the roller for transfer through the roller train onto the plates on the plate cylinder. Also, digital inking techniques have been used widely hitherto. The flow of ink needs to be carefully controlled to obtain suitable distribution across the printing plates and the ink supply rate needs to be metered as a function of the operating speed of the press in order to ensure adequate print quality on the printed web.

The dampening system applies an aqueous dampening fluid onto the plates on the plate cylinder through a dampening roller train. The dampening fluid improves the quality of printing and facilitates transfer of the ink from the plates on the plate cylinder onto the web via the blanket cylinder. Hitherto, a spray bar system has been employed in which nozzles mounted along a common fluid supply conduit, spray the fluid onto individual zones of a roller in the dampening fluid roller train, so that the fluid is transferred through the train onto the plates on the plate cylinder. The flow rate through each of the nozzles is individually controllable and needs to be carefully adjusted to achieve optimum print quality for the printed web. If too much fluid is applied it may wash out the ink on the printed web. Also, excess fluid may work back through the inking system if a fountain system is used, so as to degrade the ink supply. If not enough fluid is applied, patchy printing may be produced on the web. Hitherto, the setting of the flow rate for the individual nozzles has been carried out empirically by the press operator by monitoring the quality of the printed web and making suitable adjustments. At the start of the print run, the nozzle settings are made on the operator's best judgement of suitable values. Thus a number of unwanted poor quality copies may occur at the start of a print run whilst the settings are adjusted, reducing the productivity of the press.

Another problem is that the nozzles may become impeded with dirt or even blocked and the performance of individual nozzles on the spray bar cannot be determined easily. Thus regular maintenance is required, which involves removal and cleaning of an entire spray bar.

The present invention seeks to overcome these problems.

### SUMMARY OF THE INVENTION

According to the invention there is provided apparatus for dampening a printing press, comprising an outlet for dispensing a dampening fluid to the press, a flow rate setting device to set the flow rate of the dampening fluid to the press through the outlet, and a controller operable to control the setting device, the controller being operable to set an initial flow rate for the commencement of a print run to an initial setting value dependent on a stored value derived during at least one preceding print run, to receive updated data corresponding to an updated flow rate for the commenced print run, and to calculate said stored value in dependence upon said initial setting value and the updated data.

Thus, the dampening fluid setting for a print run is configured initially depending on the setting for one or more previous print runs, thereby providing a self learning system, with the advantage of greatly reducing the setting up time and the production of poor quality copies at the beginning of the print run

The updated data may derived by inspecting printed copy produced during the commenced print run and adjusting the setting device to optimise the printed copy, whereby the resulting setting of the setting device corresponds to the updated data. A manually operated input may be provided for adjusting the setting device so as to provide the updated data or the updating may be carried out automatically using a detector that senses the print quality.

A counter may be used to determine when a predetermined number of printed copies have been produced so that the printed copy can be inspected and the updated data obtained by adjusting the setting device.

The calculated value may be stored in a store together with a default setting value, and the controller may be operable to set the initial flow rate in dependence on the default setting value and the calculated stored value. Thus the self learning may be performed relative to a baseline set by the default value.

The controller can be configured to compute an offset value corresponding to the difference between the initial setting value and the updated data, and the calculated stored value is then calculated in dependence upon the offset value.

Individual instances of the offset value for a plurality of successive print runs, and the calculated stored value may be computed as an average of these offset values. The average may comprise a running average of a predetermined number of the offset values for the successive print runs.

An alarm detector may be provided to provide an alarm signal when the flow rate setting adopts a predetermined relationship to an alarm threshold level. This enables early identification of a degradation of performance of the outlet, for example due to a blockage.

The outlet may comprise a nozzle and the flow rate setting device may comprise an associated valve selectively operable to adjust said flow rate of dampening fluid through the nozzle in a range of settings. The valve may comprise a solenoid operated valve cyclically operable between open and closed positions, and the controller may vary the relative periods that the valve is open and closed so as to provide the range of flow rate settings.

A plurality of the outlets may be provided, for example on a spray bar, each for dispensing said dampening fluid, with individual setting devices, and the controller may operable to control the setting devices individually in a plurality of individually controllable dampening zones.

The invention also includes a method of dispensing a dampening fluid in a printing press, through an outlet having an associated a flow rate setting device, comprising setting the device to an initial setting value for the commencement of a print run, the an initial setting value being dependent on a stored value derived during at least one preceding print run, receiving updated data corresponding to an updated flow rate for the commenced print run, calculating said stored value in dependence upon said initial setting value and the updated data, and storing said calculated value for use in setting the initial setting value for a subsequent print run.

### BRIEF DESCRIPTION OF THE DRAWINGS

In order that the invention may be more fully understood an embodiment thereof will now be described by way of example with reference to the accompanying drawings in which:

FIG. 1 is a sectional view through the rollers of a multi-colour web set printing press;

FIG. 2 is a sectional view taken along the line A-A prime in FIG. 1;

FIG. 3 is a schematic sectional view of a spray bar nozzle;

FIG. 4 is a flow diagram of a self-learning system for setting the flow rate for nozzles of the spray bar; and

FIG. 5 is a flow diagram of an alarm system for indicating when nozzles are not performing optimally.

### DETAILED DESCRIPTION

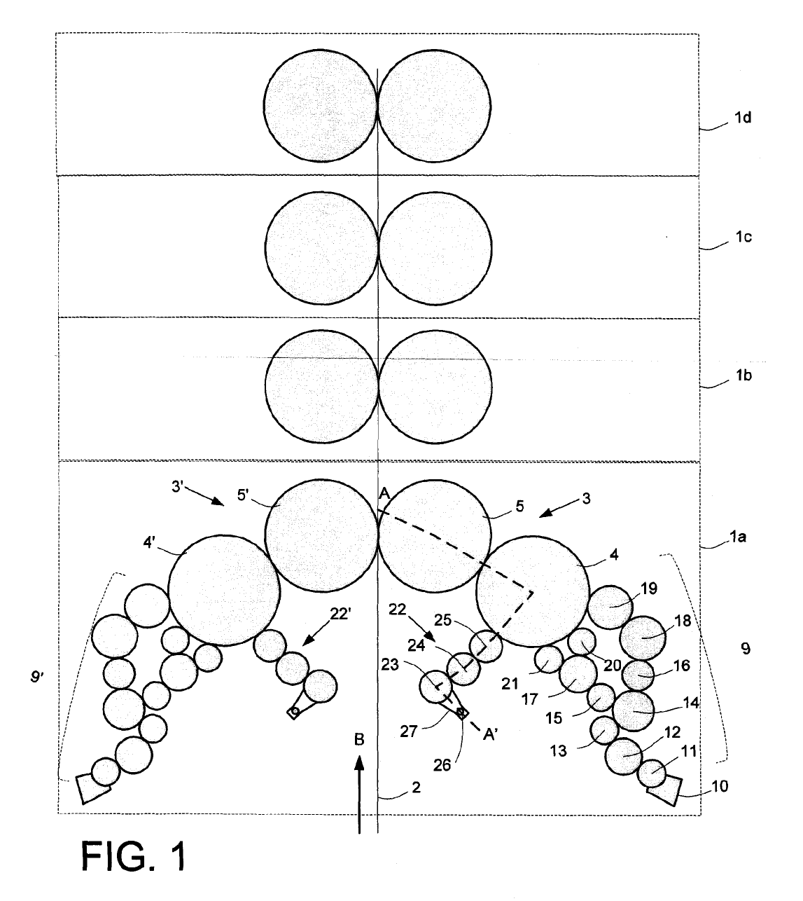

Referring to FIG. 1, a web-off set printing press comprises a number of printing units 1a, 1b, 1c and 1d stacked vertically, which print matter on to a paper web 2 that travels vertically upwardly through the print units in a direction of arrow B.

Each printing unit is operative to print a different coloured ink on to the web 2 and in the example of FIG. 1, a full-colour printing press is shown in which one of the print units 1 prints as black ink and the others may print the usual three primary colours. The cylinders and rollers for the printing unit 1a are shown in detail and the construction of printing units 1b-1d are identical but only the web-engaging cylinders are shown for these printing units in order to simplify the drawing.

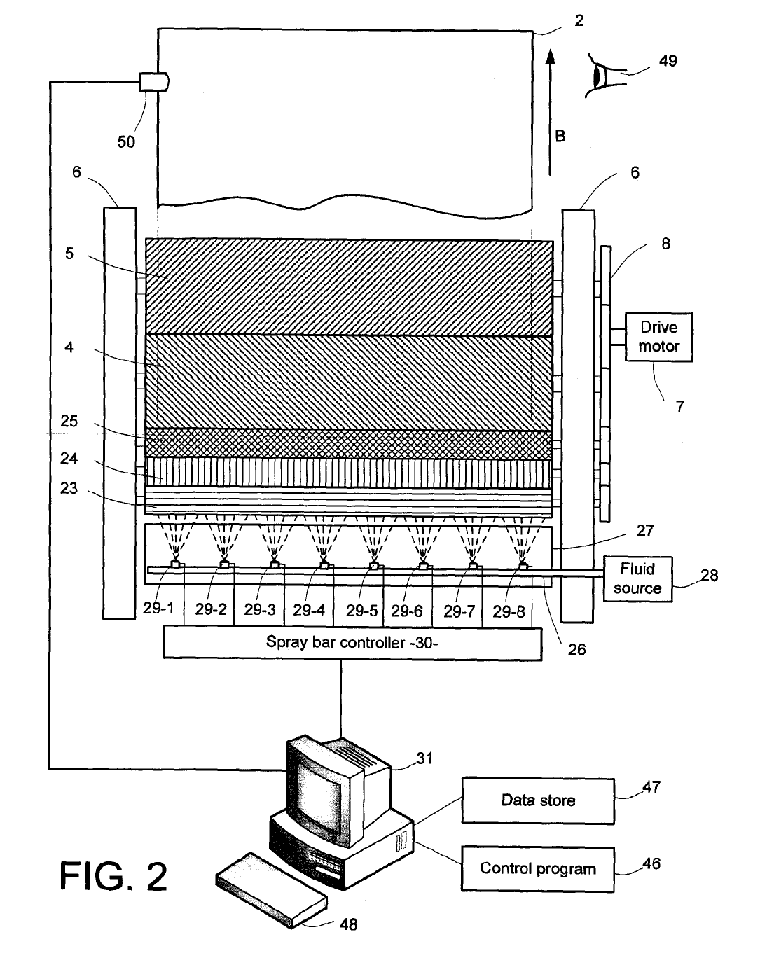

Considering the unit 1a in more detail, it includes a cylinder group 3 that comprises a rotatably mounted plate cylinder 4, to which one or more printing plates are attached (not shown), and a rotatably mounted blanket cylinder 5. The cylinders of cylinder group 3 are mounted for rotation in a frame 6 shown in FIG. 2 and are driven by an electric motor 7 through a gear train 8.

An inking system 9 associated with the cylinder group 3 feeds ink onto the printing plates on a plate cylinder 4 as it rotates. The ink contained in the reservoir 10 is transferred onto a rubber inking roller 11 and then through the rollers 12-21 onto the surface of the plates on the plate cylinder 4. The arrangement of the reservoir 10 and inking roller 11 may comprise a fountain inker in which a fountain of ink washes over the inking roller 11. Alternatively, the arrangement 10, 11 may comprise a Goss Colourflow™ system in which a rotary helical brush transfers ink from the reservoir 10 onto the ink roller 11. Alternatively, digital inking techniques may be employed.

The print unit 1a also includes a dampening system 22 for applying a dampening fluid onto the plates on cylinder 4. The dampening system includes a dampening fluid roller train comprising rollers 23, 24, 25 and a spray bar 26 contained within a trough 27. As shown in FIG. 2, the spray bar 26 comprises a conduit that supplies dampening fluid under pressure from a pumped source 28 to a series of spray bar nozzles 29-1; 29-8 that spray the fluid onto roller 23, so that it is transferred onto the surface of the printing plates on cylinder 4 by means of rollers 24, 25.

Each of the nozzles 29 sprays fluid onto the individual zone of the roller 23, so as to be transferred to a corresponding zone of the plate cylinder 4. The rollers 23, 25 may comprise rubber rollers and the roller 24 may comprise a roller with a chromed surface having hydrophilic properties to aid in transferring the dampening fluid along the roller train.

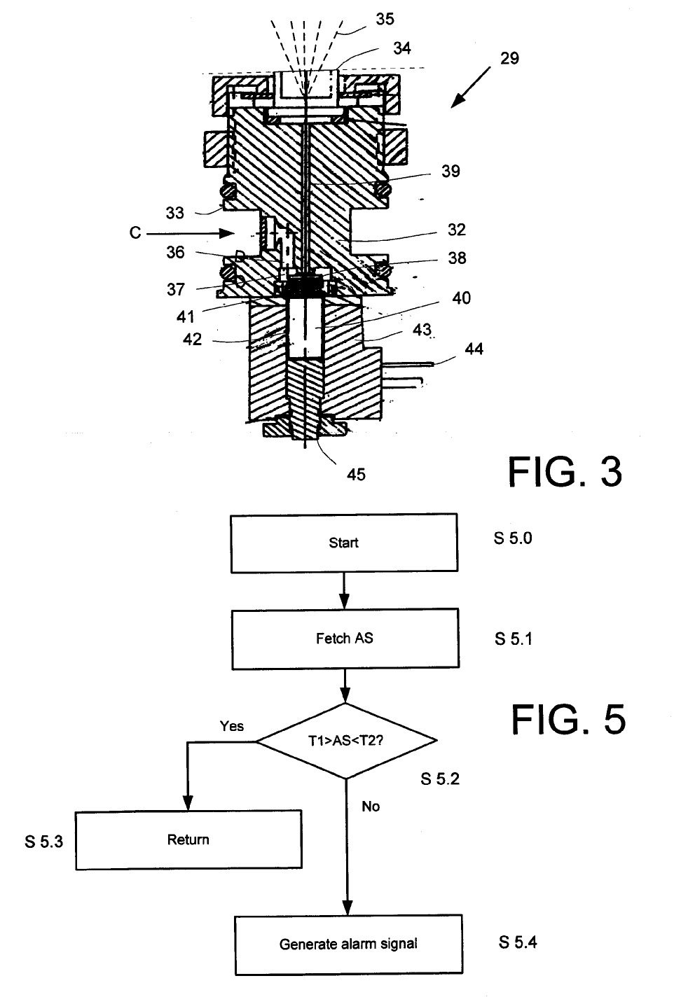

The nozzles 29 are provided with a solenoid operated valve to control the flow rate of dampening fluid onto roller 23. Each of the valves is controlled individually by a spray bar controller 30 which in turn is controlled by a workstation 31. A sectional view through one of the nozzles is shown in FIG. 3. A nozzle main body 32 receives dampening fluid through a spur (not shown) from the conduit 27 through inlet opening 33 in a direction of arrow C and the fluid is ejected through nozzle outlet 34 in a spray 35 to roller 23. The body 32 includes an inlet 36 bore which extends from opening 33 to a plenum 37 containing a valve seat 38. A central outlet bore 39 extends from the valve seat 38 to the nozzle outlet 34. A moveable valve member 40 biased by a spring 41 is axially slidably mounted in a central bore 42 in an armature housing 43 that contains a solenoid coil with electrical terminals 44 that receive a cyclic electric driving signal from the spray bar controller 30. The bore 42 is closed by an axial threaded end piece 45. The valve member 40 is made of metal and can be moved back and forth by energising the solenoid coil against the force of the spring 41, to and from the valve seat 38, thereby opening and closing the valve. The flow rate for the spray 35 emitted from the nozzle can be controlled by varying the relative periods that the solenoid coil is energised and de-energised for each cycle. In one example, the solenoid coil is energised at a frequency of 5 Hz and the mark to space ratio of the energising currents is varied by the spray bar controller 30 so as to set the desired flow rate for the spray 35. It will be understood that the fluid flow through each of the nozzles 29-1: 29-8 can be set individually by the spray bar controller 30 shown in FIG. 2.

Thus, in use, the printing plates on cylinder 4 are both inked and provided with dampening fluid so that, referring to FIG. 1, the inked and damped image is transferred onto blanket cylinder 5 and then to one side of the web 2 as it moves through the printing unit 1a. The dampening fluid can be water or a proprietary aqueous or other solution used conventionally. Suitable examples of dampening fluids will be well known to those skilled in the art.

As shown in FIG. 1, the printing unit 1a includes a corresponding set of rollers and cylinders for printing on the other side of the web, with a corresponding cylinder pair 3′, an associated inking system 9′ and a dampening system 22′, which operate in an identical manner to those just described.

It will be understood that the blanket cylinder 5′ acts as an impression cylinder for the blanket cylinder 5 and vice versa. The paper web 2 is fed from a reelstand (not shown) through the print units 1 successively and then to a splitter and folder (not shown) in a manner well known in the art. The arrangement shown in FIG. 1 is suitable for full colour printing of newspapers, with each plate cylinder being configured to print 4 pages concurrently, side by side. Two of the nozzles 29 may be allocated to provide dampening fluid for each of the pages.

As previously explained, the dampening fluid improves the quality of printing and the transfer of the ink from the plates on plate cylinder 4 onto the printed web 2. If too much fluid is applied, it may wash out the ink on the printing web 2. Also, excess fluid may work back through the inking system 9 so as to degrade the ink supply in the reservoir 10 if a fountain system is used. Conversely, if not enough dampening fluid is applied, patchy printing may be produced on the web.

In accordance with the invention, the settings for the flow rate of the nozzles 29-1: 29-8 is set under the control of a program 46 run by the workstation 31, utilising data held in a data store 47. It will be appreciated that in practice, the control program 46 and data store 47 will be within the conventional memory of the work station 31 and selected for operation by means of its keyboard 48 so as to be run by its internal microprocessor. Various operational parameters for the program are displayed on the screen 49 of the workstation 31.

The control program 46 controls operation of the spray bar controller 30 so as to set the flow rate for the nozzles 29-1: 29-8 individually on the basis of default settings stored in the data store 47 and also averaged, updated settings derived from successive print runs. The flow rate is controlled by varying the time that each solenoid operative valve 29 is switched on during a duty cycle. Thus, for example, if the solenoid operated valves 29 are switched on and off at a constant duty cycle of e.g. 5 Hz, this corresponds to a valve cycle time of 200 Ms. As shown in Table 1 below, a series of default settings D are illustrated for setting the on-times of the individual nozzles 29-1: 29-8. Thus, for nozzle 29-1, the default on-time D is 26 Ms, which means that the default open time for valve 29-1 is 26 Ms and that it will be closed for the remainder of the 200 Ms period. Corresponding individual default times D for the other nozzles 29-2: 29-8 are shown. These default settings D may be derived using the best skill and knowledge of the print process operator when the printing press is first set up for operation. In accordance with the invention, these default setting are modified by a parameter AVOFS, which is an average offset computed in dependence upon data derived from successive print runs, as will be explained in more detail later. Thus, for each print run, an initial setting IS for each nozzle 29 is determined, based on the default setting D and the value of the offset AVOFS from the default setting, as shown by way of example in Table 1.

TABLE 1

| | Nozzle | | | | | | | |
|---|---|---|---|---|---|---|---|---|
| | 29-1 | 29-2 | 29-3 | 29-4 | 29-5 | 29-6 | 29-7 | 29-8 |
| Default D (Ms) | 26 | 21 | 21 | 21 | 21 | 21 | 21 | 26 |
| AVOFS (Ms) | 2 | −1 | 0 | 0 | −3 | −2 | 1 | −2 |
| Initial setting | 24 | 20 | 21 | 21 | 18 | 19 | 22 | 24 |
| IS (Ms) | | | | | | | | |

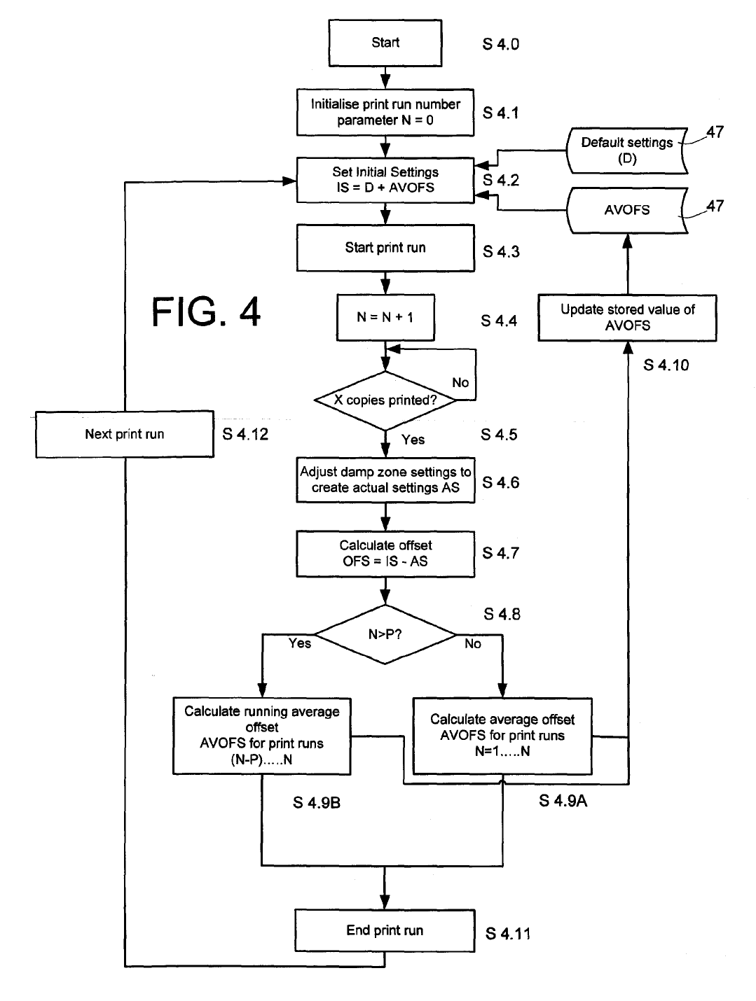

FIG. 4 illustrates a process performed by the control program 46. The process starts at step s4.0 and a print run number parameter N is initially set to 0 at step s4.1. The parameter N counts the number of print runs performed on the press.

At step s4.2, initial settings for the nozzle 29 (IS) are computed based on the sum of the default settings D and the correction AVOFS which are both held in the data store 47. For the first print run, each value of AVOFS is typically zero, but thereafter becomes updated by the process described below.

At step s4.3, the print run starts and at step s4.4, the print run parameter N is incremented.

The press is then allowed to run up to speed and reach its normal operating temperature e.g. by printing X=3,000 copies. The print number may be counted by a counter function performed by the workstation 31 on the basis of the usual data available to it from the press, which may be provided by sensors (not shown). This counting function is illustrated at step s4.5.

Then, at step s4.6, the operator visually inspects the quality of the printed copy on web 2 as illustrated at 49 in FIG. 2 and if necessary, then uses the keyboard 48 to adjust the settings for the solenoid operated valves in order to improve the quality of the printed copy. As a result, actual settings AS are created for the individual nozzles 29-1: 29-8.

Alternatively, a detector 50 may be employed to detect the print quality automatically and provide data to the workstation 31, as shown in FIG. 2, in order to create the actual settings AS automatically.

At step s4.7, an offset OFS is calculated for the print run based on the difference between the initial settings IS and the actual settings AS for the nozzles 29 individually.

The print run then is continued using the actual settings AS i.e. the settings which optimise print quality for the particular print run.

At steps s4.8 and s4.9A or s4.9B, an average of the offset OFS, namely AVOFS is computed for successive print runs and is thereafter used at step s4.10 to update the stored value held in data store 47. In general terms, the value of AVOFS is computed as a running average of the last P offset values OFS i.e. the offset values for the last P print runs. For example, the average may be taken over the last P=10 print runs.

For the first print run, N is less than P as determined at step s4.8 and so the average is computed at step s4.9A. In fact, for the first print run, the single computed value of OFS is used to update the value of AVOFS held in store 47, which was initially zero. For the next print run where N=2 and hence N<P, AVOFS is computed at step s4.9A to be the average OFS for the first two print runs and the value of AVOFS is updated in store 47 at step s4.10. The process continues until P=10 print runs have occurred and thereafter, the value of AVOFS is computed at step s4.9B so as to be a running average of OFS for the last P=10 print runs.

Each print run ends at step s4.11 and the next print run is initiated at step s4.12 when the initial settings IS for the individual nozzles 29 are set according to the values computed at step s4.2.

The described control routine has the advantage that the individual settings for the nozzles 29 can be maintained more accurately, based on the data from preceding print runs. Moreover, because an average is taken, spurious readings produced during one print run do not produce wild swings for the initial settings IS for the subsequent print run.

Thus, in accordance with the invention, the settings for the flow rate through the individual nozzles 29-1: 29-8 are set individually and are continuously updated on the basis of data from preceding print runs. This has the advantage that at start up of print run, the number of trial copies that need to be printed and discarded is materially reduced since the initial settings IS are more closely based on the likely actual settings AS needed for the run, rather than being based solely on the print press operators' best judgement.

Also the self learning system has the advantage that if a nozzle becomes partially blocked over time, the stored value of the average offset AVOFS adjusts the initial settings IS for the next print run so as to take account of and compensate for the partial blockage.

The invention also allows a predetermined threshold to be set for the flow rate through the nozzles individually so that if a nozzle becomes blocked so as to result in a spray flow rate below a predetermined threshold limit, an alarm signal can be produced to notify the machine operator that servicing is required for the particular nozzle 29. Referring to FIG. 5, the control program 46 (FIG. 2) operates a routine in which the individual values of the actual setting values AS are fetched in turn at step s5.1 and are individually compared with upper and lower threshold limits T1, T2. The threshold limit T2 corresponds to a blockage of the individual nozzle 29 since the actual value AS had to be increased to such a level to produce an adequate flow of fluid onto the dampening roller 23. The value of AS is checked against the thresholds T1 and T2 at step s5.2. If the value of AS falls within the threshold limits T1 and T2, the process returns to check further values of AS, as shown at step s5.3. However, if the value of AS falls outside of the threshold limits T1, T2, an alarm signal is generated at step s5.4 and a corresponding display may be provided on the screen 49 of the workstation 31 shown in FIG. 2. It will be understood that the alarm signal can pinpoint an individual blocked nozzle 29, which enables the servicing of the spray bar to be carried out more effectively than hitherto.

The display on screen 49 may also include a display of the alarm limits, i.e. thresholds T1 and T2, a cursor operated control to allow the number X of copies to be adjusted before the actual values AS are set, and also a display of the actual values AS currently being used together with the corresponding value of AVOFS for each nozzle.

Also, the apparatus may be switchable between the previously described self learning mode and a mode in which the default values D alone are used as the settings, under the control of the press operator.

Furthermore, the screen may include a display which corresponds to the physical arrangement of print units 1 in a particular press, which is configurable for different print units depending on the architecture of a particular print press installation.

Many modifications and variations fall within the scope of the invention as set out in the claims. For example, whilst the flow rate of the spray nozzles 29 has been described as being controlled by the solenoids energised at a fixed frequency with a variable duty cycle, it will be understood that the frequency itself can be varied whilst using a fixed on-time, or both the duty cycle and the frequency can be varied. Other flow rate control schemes can be used and for example analogue control valves can dispense the dampening fluid, operated by an analogue control signal to control the fluid flow rate.

The invention is not restricted to newspaper printing presses and can be used in any press that utilises a dampening fluid system.

1. Apparatus for dampening a printing press, comprising an outlet to dispense a dampening fluid to the press, a flow rate setting device to set the flow rate of the dampening fluid to the press through the outlet, and a controller operable to control the setting device, the controller being operable to set an initial flow rate for the commencement of a print run to an initial setting value dependent on a stored value derived during at least one preceding print run, to receive updated data corresponding to an updated flow rate for the commenced print run, and to calculate said stored value in dependence upon said initial setting value and the updated data.

2. Apparatus according to claim 1 wherein the updated data is derived by inspecting printed copy produced during the commenced print run and adjusting the setting device to optimise the printed copy, whereby the resulting setting of the setting device corresponds to the updated data.

3. Apparatus according to claim 2 including a manually operated input for adjusting the setting device, whereby to provide the updated data.

4. Apparatus according to claim 2 including a printed copy counter for indicating when a predetermined number of printed copies have been produced so that the printed copy can be inspected and the updated data obtained a adjusting the setting device.

5. Apparatus according to claim 2 including a detector for detecting the quality of the printed copy for setting the setting device to obtain said updated data.

6. Apparatus according to claim 1 including a data store to store said calculated stored value.

7. Apparatus according to claim 6 wherein the store is operable to store a default setting value and said calculated stored value, and the controller is operable to set the initial flow rate in dependence on the default setting value and the calculated stored value.

8. Apparatus according to claim 1 wherein the controller is configured to compute an offset value corresponding to the difference between said initial setting value and the updated data, and the calculated stored value is calculated in dependence upon the offset value.

9. Apparatus according to claim 8 wherein the controller is operable to compute the offset value for each of a plurality of successive print runs, and to compute the calculated stored value as an average of the offset values.

10. Apparatus according to claim 9 wherein said average comprises a running average of a predetermined number of said offset values for preceding print runs.

11. Apparatus according to claim 1 including an alarm detector operable to provide an alarm signal when the flow rate setting adopts a predetermined relationship to an alarm threshold level.

12. Apparatus according to claim 1 wherein said outlet comprises a nozzle and the flow rate setting device comprises an associated valve selectively operable to adjust said flow rate of dampening fluid through the nozzle in a range of settings.

13. Apparatus according to claim 12 wherein the valve comprises a solenoid operated valve cyclically operable between open and closed positions, and the controller is operable to vary the relative periods that the valve is open and closed whereby to provide the range of flow rate settings.

14. Apparatus according to claim 1 including a plurality of the outlets each for dispensing said dampening fluid, with individual setting devices, and the controller is operable to control the setting devices individually.

15. Apparatus according to claim 14 including a spray bar with a plurality of nozzles for dispensing said dampening fluid a plurality of individually controllable dampening zones.

16. A printing press including dampening apparatus as claimed in claim 1.

17. A press according to claim 16 including a plate cylinder and a blanket cylinder, said dampening apparatus being operable to apply dampening fluid to the plate cylinder.

18. A press according to claim 17 including an ink roller train for applying ink to the plate cylinder, and a dampening roller train operable to apply the dampening fluid to the plate cylinder, the or each said outlet being configured to dispense the dampening fluid onto at least one dampening zone on a roller in said dampening roller train for transfer through the train onto the plate cylinder.

19. A method of dispensing a dampening fluid in a printing press, through an outlet having an associated a flow rate setting device, comprising setting the device to an initial setting value for the commencement of a print run, the initial setting value being dependent on a stored value derived during at least one preceding print run, receiving updated data corresponding to an updated flow rate for the commenced print run, calculating said stored value in dependence upon said initial setting value and the updated data, and storing said calculated value for use in setting the initial setting value for a subsequent print run.

20. A method according to claim 19 wherein the updated data is derived by inspecting printed copy produced during the commenced print run and adjusting the setting device to optimise the printed copy, whereby the resulting setting of the setting device corresponds to the updated data.

21. A method according to claim 20 including counting the number of printed copies have been produced up to a predetermined threshold so that the printed copy can be inspected and the updated data obtained by adjusting the setting device.

22. A method according to claim 19 including storing a default setting value and setting the initial flow rate in dependence on the default setting value and the calculated stored value.

23. A method according to claim 19 including computing an offset value corresponding to the difference between said initial setting value and the updated data, and calculating the calculated stored value in dependence upon the offset value.

24. A method according to claim 23 including computing the offset value for each of a plurality of successive print runs, and computing the calculated stored value as an average of the offset values.

25. A method according to claim 24 including computing said average as a running average of a predetermined number of said offset values for preceding print runs.

26. A method according to claim 19 including signaling an alarm when the flow rate setting adopts a predetermined relationship to an alarm threshold level.

27. A method according to claim 19 wherein said outlet comprises a nozzle and the flow rate setting device comprises an associated solenoid operated valve selectively operable to adjust said flow rate of dampening fluid through the nozzle in a range of settings, and the method includes cyclically operating the valve between open and closed positions and varying the relative periods that the valve is open and closed whereby to provide the range of flow rate settings.

28. A method according to claim 19 including a plurality of the outlets each for dispensing said dampening fluid, with individual setting devices, and controlling the setting devices individually.
